(19) United States
(12) Patent Application Publication
(10) Pub. No.: US 2012/0055903 A1
(43) Pub. Date: Mar. 8, 2012

(54) FLUX-CORED WELDING WIRE AND METHOD FOR ARC OVERLAY WELDING USING THE SAME

(75) Inventors: Shun Izutani, Fujisawa-shi (JP); Reiichi Suzuki, Fujisawa-shi (JP); Yushi Sawada, Fujisawa-shi (JP); Hirohisa Watanabe, Fujisawa-shi (JP)

(73) Assignee: Kabushiki Kaisha Kobe Seiko Sho (Kobe Steel, Ltd.), Kobe-shi (JP)

(21) Appl. No.: 13/070,097

(22) Filed: Mar. 23, 2011

(30) Foreign Application Priority Data
Sep. 6, 2010 (JP) 2010-198653

(51) Int. Cl. B23K 9/16; B23K 35/02

(52) U.S. Cl. 219/74; 219/145.22

(57) ABSTRACT

To provide a flux-cored welding wire and a method for arc overlay welding attaining excellent weldability and low dilution ratio and obtaining a weld bead excellent in corrosion resistance in overlay welding using the flux-cored welding wire having an advantage of high deposition rate and deposition efficiency. The flux-cored welding wire for gas shielded arc welding including flux filled up in an outer sheath and using pure Ar as a shielding gas contains, as percentage to the total mass of the flux-cored welding wire, C: 0.20 mass % or below, Si: 15.00 mass % or below, Mn: 20.00 mass % or below, P: 0.0500 mass % or below, S: 0.0500 mass % or below, and Cr: 15.0-50.0 mass %, with the remainder being Fe and inevitable impurities.

### BACKGROUND OF THE INVENTION

1. Field of the Invention

The present invention relates to a flux-cored welding wire for gas shielded arc welding used for different material welding representing overlay welding and a method for arc overlay welding using the same.

2. Description of the Related Art

Overlay welding is a welding in which a metal is deposited on the surface of a base metal for the purpose of improving corrosion resistance, repairing and regenerating the base metal, hardening of the surface of the base metal, and the like. In performing overlay welding, it is preferable that the base metal is molten as little as possible in welding from the viewpoint that dilution of the base material composition greatly affects the weld metal.

Particularly, with respect to overlay welding of the different materials in which an alloy with high corrosion resistance such as stainless steel and the like is welded to mild steel or low alloy steel, the base metal composition is diluted much, and it was usually necessary to select welding material taking the dilution ratio into consideration. In particular, because the boundary section (initial layer) showed extremely great dilution, it was necessary to use the welding material with different additive element for the boundary section only.

Also, having regard to the fact that hot cracking is generated when the structure of the weld metal changes because of dilution of the base metal composition, it is necessary to minimize dilution (minimize the penetration) and to control the weld metal structure of ferrite+austenite (4-8% for ferrite quantity).

Further, as an example of different material welding, overlay welding on the inner surface of a pressure vessel can be cited, and its welding is performed mainly by a submerged arc or electroslag welding method using a strip-like welding material. For the locations where such welding methods are not applicable, a gas shielded arc welding method and shielded metal arc welding method are applied. In particular, the gas shielded arc welding method is rapidly spreading because of high efficiency and capability for automation and semi-automation.

In view of such circumstances, technologies have been developed in which the dilution ratio of the base metal composition is lowered in overlay welding by the gas shielded arc welding method. For example, in Japanese Unexamined Patent Application Publication No. H8-206832, a technology for obtaining excellent weld bead shape and penetration by limiting the weaving condition to a predetermined range is disclosed.

However, in the technology in relation with Japanese Unexamined Patent Application Publication No. H8-206832, a large amount of spatters are generated when the weaving condition deviates from the stipulated range, and a separate device for performing weaving becomes necessary. Also, because 100% CO₂ is used as a shielding gas, the spatters and fume are liable to be generated much, which is disadvantageous in workability and hygienic viewpoint.

Also, with respect to the gas shielded arc welding wire, there are a solid wire and a flux-cored welding wire. Out of them, the flux-cored welding wire has the advantage of high deposition rate and deposition efficiency, has the disadvantage, on the other hand, of generating a large amount of fume when compared with the solid wire, is believed to generate hexa-valent chromium supposed to be highly harmful among the compositions containing chromium, and is highly liable to ruin the health of the welding workers, therefore its reduction is hoped.

### SUMMARY OF THE INVENTION

Accordingly, an object of the present invention is to provide a flux-cored welding wire and a method for arc overlay welding attaining excellent weldability and a low dilution ratio and obtaining a weld bead excellent in corrosion resistance in performing overlay welding using a flux-cored welding wire having the advantage of high deposition rate and deposition efficiency.

In order to achieve the object, the present inventors studied on the following points.

Usually, 100% CO₂ or Ar+20% CO₂ is used as a shielding gas in overlay welding, however when O₂, CO₂ and the like are mixed into the shielding gas, oxides are easily generated, and the penetration becomes deep (the base material composition is diluted greatly) because of deterioration of workability such as increase of the fume and the like and concentration of the arc.

In the regard, the present inventors considered to use pure Ar gas of 100% Ar which is an inert gas as the shielding gas. The reason is that the pure Ar gas is low in a potential gradient and has effects of increasing the width of an arc and inhibiting penetration. Another reason is that the Ar gas has an advantage that the amount of fume is reduced because it is inert and metal gas generated in welding becomes hard to be oxidized when 100% Ar gas is used.

However, conventionally, the Ar gas was not used for gas metal arc welding. The reason is that the potential gradient tends to be low in welding using the pure Ar gas, therefore the arc length (distance between electrodes) becomes long, the influence of the plasma gas flow becomes great, and the transfer mode of a molten droplet is liable to become streaming transfer in which the molten section (liquid column) at the tip of the electrode becomes narrow and rotating transfer in which the liquid column itself rotates. Also, on the surface of the molten metal pond side, an oxide becomes a generation spot of an arc as an anode spot, however stable oxide is hardly generated inside the pure Ar gas which is an inert gas, therefore the arc generation spot moves, and the arc becomes unstable which is another reason.

Welding using pure Ar gas had such disadvantages that extreme defectiveness of the bead shape called a wandering phenomenon occurred and workability such as increase of the spatters deteriorated because of combination of the phenomenon of narrowing of the tip of the electrode and the phenomenon of unstable arc. Therefore, with respect to a steel-based wire (flux-cored welding wire), it was considered that there was no technique to avoid this problem occurring when pure Ar gas is employed, and it has been a common sense that pure Ar gas cannot be used.

In this connection, there are technologies of (1) double solid (Japanese Unexamined Patent Application Publication No. 2006-205204) and (2) MIG welding method combined pure Ar shielding gas and flux-cored wire for carbon steel (Japanese Unexamined Patent Application Publication No. 2009-255125) similarly utilizing pure Ar gas as described in “Proposal on hybrid wire”, Yousetu Gijyutu (Welding Technology) (February 2006), p. 64, as well as (3) plasma MIG, however any of them was insufficient with respect to the cost and stabilizing measures. Also, in the technology of (2), the pure Ar shielding gas was applied to a flux-cored welding wire of carbon steel, however possibility of applying it to that of high-Cr stainless steel and Ni-alloy was not studied. In the carbon steel flux-cored welding wire, graphite is used as the flux for stabilizing the arc in the pure Ar shielding gas, however when graphite is added, the carbon quantity in the weld metal inevitably increases. On the other hand, with respect to stainless steel and Ni-alloy containing a large quantity of Cr, Cr carbide is generated on the boundary when a large quantity of carbon is present, boundary corrosion due to lack of Cr and stress corrosion cracking accompanying it occur, and therefore graphite cannot be used for stabilizing the arc in the pure Ar shielding gas. This is the reason the pure Ar shielding gas was not applied to stainless steel and Ni-alloy.

In relation with the phenomena described above, according to the present invention, the arc was stabilized in the pure Ar atmosphere by using Cr metal powder instead of graphite. Also, by containing an appropriate quantity of a strong oxidizing element such as Mn, Si and the like in the wire, stabilized oxide was generated on the molten metal pond, and the arc was stabilized more.

Below, the present invention will be described in detail.

In order to attain the object described above, a flux-cored welding wire in relation with the present invention is a flux-cored welding wire for gas shielded arc welding including flux filled up in an outer sheath and using pure Ar as a shielding gas, containing, as percentage to the total mass of the flux-cored welding wire, C, 0.20 mass % or below, Si: 15.00 mass % or below, Mn: 20.00 mass % or below, P: 0.0500 mass % or below, S: 0.0500 mass % or below, and Cr: 15.0-50.0 mass %, with the remainder being Fe and inevitable impurities.

Also, a flux-cored welding wire in relation with the present invention may preferably contain further, as percentage to the total mass of the flux-cored welding wire, Ni: 5.00-80.00 mass %.

Also, a flux-cored welding wire in relation with the present invention may preferably contain further, as percentage to the total mass of the flux-cored welding wire, one or more kind selected from the group consisting of Ti: 1.00 mass % or below, Al: 1.000 mass % or below, Mo: 15.000 mass % or below, Nb: 5.00 mass % or below, N: 0.0800 mass % or below, Cu: 5.00 mass % or below, and V: 1.000 mass % or below.

Thus, in the flux-cored welding wire in relation with the present invention, the flux is filled up inside the outer sheath (the flux is filled up in the center of the wire), and the flux is not molten during welding and therefore is present as a column of the flux. Accordingly, the column of the flux becomes a core, therefore the phenomena that the molten metal section (liquid column) at the tip of the electrode is narrowed or rotates like in the case of a solid wire can be inhibited, and molten droplet transfer can be stabilized.

Also, in the flux-cored welding wire in relation with the present invention, by adding an appropriate quantity of Mn, Ti, Al and the like having strong deoxidizing action even in pure Ar into the flux-cored wire, stable oxide can be supplied onto the molten metal pond, and the arc can be stabilized more. Thus, a normal bead shape can be obtained, and the spatters can be reduced. Also, as an effect of pure Ar shielded gas welding, low fume and low dilution ratio can be attained, and the best result as the overlay welding can be obtained. In addition, because the dilution ratio is low, control of the initial layer composition is not necessary, and the weld metal structure can be easily controlled.

Also, a flux-cored welding wire in relation with the present invention may preferably use stainless steel for the outer sheath.

The flux-cored welding wire in relation with the present invention can improve corrosion resistance of the wire itself and make the wire itself hard to be rusted because stainless steel is thus used for the outer sheath.

Also, a filling factor of flux of a flux-cored welding wire in relation with the present invention may preferably be 7-27 mass % as percentage to the total mass of the flux-cored welding wire.

The flux-cored welding wire in relation with the present invention can inhibit the phenomenon of narrowing of the molten metal section (liquid column) at the tip of the electrode by limiting thus the filling factor of the flux to a predetermined range.

Also, in a method for arc overlay welding in relation with the present invention, arc welding is performed using a predetermined flux-cored welding wire and using pure Ar as a shielding gas.

According to the method for arc overlay welding in relation with the present invention, welding is thus performed using pure Ar as a shielding gas, and therefore low fume and low dilution ratio can be attained.

Also, in a method for arc overlay welding in relation with the present invention, it is preferable that pulse current is used as welding current in the arc welding, peak current of the pulse current is 350-550 A, peak current period of the pulse current is 0.5-3.5 msec, the peak current is 350-550 A when the peak current period is 0.8-3.0 msec, the peak current is 500-550 A when the peak current period is 0.5 msec or longer and shorter than 0.8 msec, and the peak current is 350-380 A when the peak current period is longer than 3.0 msec and 3.5 msec or shorter.

According to the method for arc overlay welding in relation with the present invention, the pulse current is used thus as the welding current, and therefore weldability (less spatters and less fume) can be improved. Also, by limiting the peak current and the peak current period to a predetermined range, improvement of weldability can be secured.

According to the flux-cored welding wire and the method for arc overlay welding in relation with the present invention, because the pure Ar is used as a shielding gas and the flux-cored welding wire is of a predetermined composition, excellent weldability (less spatters and less fume) and low dilution ratio can be attained, and the weld bead excellent in corrosion resistance can be obtained.

Also, according to the flux-cored welding wire in relation with the present invention, corrosion resistance of the wire itself can be improved, and the narrowing phenomenon of the molten metal section (liquid column) at the tip of the electrode can be inhibited.

### BRIEF DESCRIPTION OF THE DRAWINGS

FIG. 1 is a drawing showing the relation between Cr dilution ratio and fume quantity in welding using each shielding gas.

FIG. 2 is a cross-sectional macro photo of the base metal and the weld metal in welding using each shielding gas.

FIG. 3 is a drawing showing appropriate conditions of the pulse when the pulse current is used for the welding current.

### DESCRIPTION OF THE PREFERRED EMBODIMENTS

Embodiments of the flux-cored welding wire and the method for arc overlay welding in relation with the present invention will be described.

### {Flux-Cored Welding Wire}

The flux-cored welding wire (hereinafter referred to as “wire” as the case may be) in relation with the present invention is composed of an outer sheath of a tubular shape and flux filled up inside the outer sheath. Also, the flux-cored welding wire may be either of a seamless type without a seam on the outer sheath, or of a seam type with a seam on the outer sheath.

Further, the flux-cored welding wire may be or may not be subjected to copper plating on the surface of the wire (outside the outer sheath).

Also, the flux-cored welding wire in relation with the present invention is characterized to contain a predetermined quantity of C, Si, Mn, P, S, and Cr with the remainder being Fe and inevitable impurities.

Below, the value range of the content of the flux-cored welding wire (quantity of C, Si, Mn, P, S, and Cr) will be described along with the limiting reason. In the regard, the content represents the total of the contents in the outer sheath and in the flux, and the mass of each composition contained in the wire (outer sheath+flux) is stipulated by percentage to the total mass of the wire.

### (C, 0.20 Mass % or Below (Inclusive of 0 Mass %))

C is a strong austenite generating element and is an element solid-dissolved and enhancing the strength. When C is excessively present exceeding 0.20 mass %, carbide of Cr is generated, which becomes the cause of deterioration of corrosion resistance and of stress corrosion cracking. Also, because C becomes the cause of generation of the spatters at a high level, C content is preferable to be as little as possible, and even C-free is not a problem. Therefore C is to be in the range of 0.20 mass % or below (inclusive of 0 mass %).

### (Si: 15.00 Mass % or Below (Inclusive of 0 Mass %))

Si is an effective deoxidizing agent and a strong ferrite generating element. However, in pure Ar gas welding, oxidation hardly occurs and Cr which is a same ferrite generating element is inevitably added, and therefore welding can be performed even in C-free without any problem. Also, it is preferable to add Si by 0.20 mass % or above because the shape of the toe of a bead is improved. On the other hand, when Si exceeds 15.00 mass %, embrittlement and cracking occur because of increase of the ferritic phase. Further, the bead shape is deteriorated because humping occurs and the like in high speed welding. Therefore, the range of Si is to be 15.00 mass % or below (inclusive of 0 mass %), preferably 0.20-15.00 mass %.

### (Mn: 20.00 Mass % or Below (Inclusive of 0 Mass %))

Similar to Si, Mn is an effective deoxidizing agent. Also, Mn is an austenite stabilizing element, and has an effect of lowering the transformation point. However, because deoxidization is not required in pure Ar gas welding, welding can be performed even in Mn-free without any problem. On the other hand, when Mn exceeds 20.00 mass %, the weld metal structure becomes of a single phase of austenite and easily cracks, and the bead shape deteriorates because humping occurs and the like in high speed welding. Therefore, the range of Mn is to be 20.00 mass % or below (inclusive of 0 mass %).

### (P, S: 0.0500 Mass % or Below (Inclusive of 0 Mass %))

P and S are Harmful Elements and Promote Cracking by Generating an eutectic membrane and segregating in the boundary. Therefore, P and S are to be controlled to 0.0500 mass % or below. Even the content of 0 mass % does not cause any problem at all.

### (Cr: 15.0-50.0 Mass %)

Cr becomes a basic composition of corrosion resistant materials, is excellent in corrosion resistance, and is also the most important element of stainless steel, for example. Also, Cr has the melting point higher than that of Fe by 300° C. or more, stabilizes the flux column in the arc, is easily ionized because the ionization potential of Cr is lower than that of Fe by approximately 1 eV, is therefore excellent in stability of an arc, and has an effect of further improving stability of pure Ar gas shielded welding. When the content of Cr is below 15.00 mass %, a passive state cannot be maintained, and cracking due to corrosion occurs. On the other hand, when Cr is added exceeding 50.00 mass %, cracking by embrittlement occurs. Therefore, the range of Cr is to be 15.0-50.0 mass %.

### (Fe and Inevitable Impurities)

Fe in the remainder corresponds to Fe forming the outer sheath and/or Fe on the iron powder and alloy powder attached to the flux.

The inevitable impurities in the remainder are allowed to contain the composition other than those described above in a range not interfering with the effect of the present invention.

Also, the flux-cored welding wire in relation with the present invention may preferably further contain Ni by a predetermined quantity in addition to the wire composition described above.

Below, the value range of the content of the flux-cored welding wire (Ni quantity) will be described along with the limiting reason.

### (Ni: 5.00-80.00 Mass %)

Ni lowers the Ms point, stabilizes austenite, and improves corrosion resistance and low temperature toughness. Ni is a main element of, for example, austenite-system stainless steel, inconel, hastelloy, and the like. Also, Ni has characteristics of generating single phase state of austenite and easily causing hot cracking when the content is excessively high. Accordingly, when Ni content is below 5.00 mass %, austenite becomes unstable and martensite is generated, and cracking occurs because substantial hardening occurs. On the other hand, when Ni content exceeds 80.00 mass %, hot cracking occurs. Therefore, the range of Ni is to be 5.00-80.00 mass %.

Also, the flux-cored welding wire in relation with the present invention may preferably further contain one or more of predetermined quantity of Ti, Al, Mo, Nb, N, Cu and V in addition to the composition of the wire described above.

Below, the value range of the content of the flux-cored welding wire (quantity of Ti, Al, Mo, Nb, N, Cu and V) will be described along with the limiting reason.

### (Ti: 1.00 Mass % or Below)

Ti is a strong deoxidizing element, and is an element forming stable oxide, carbide and nitride and contributing to refining of the grain and the like. Also, because Ti forms stable oxide even in pure Ar gas, the arc is stabilized. Because welding is performed in pure Ar gas, Ti is not required as a deoxidizing element, and even Ti-free is not a problem. Further, with respect to workability also, the weld bead is stabilized because of the flux column, and therefore, even in Ti-free, the spatters decrease than in the case of the conventional welding method (Ar+20% CO₂). On the other hand, when Ti is added exceeding 1.00 mass %, oxide of a quantity more than required for stabilization is generated, and the spatters increase more than that in the conventional method. Also, when Ti is added by 0.10 mass % or above, the arc is stabilized more with the oxide being the starting spot, and welding can be performed more stably even in pure Ar gas. On the other hand, when Ti is added exceeding 0.80 mass %, oxide of a quantity more than required for stabilization is generated, and the spatters are liable to increase. Therefore, the range of Ti is to be 1.00 mass % or below, preferably 0.10-0.80 mass %.

### (Al: 1.000 Mass % or Below)

Similar to Ti, Al is a strong deoxidizing element, is an element forming stable oxide, carbide and nitride and contributing to refining of the grain and the like, and forms stable oxide even in pure Ar gas. However, Ti oxide is lower in thermal electron emission characteristic (Ti oxide: 2-4 eV, Al oxide: 4-5 eV), and Ti oxide carries the main role in stabilization of an arc. Accordingly, Al carries the supplementary role, even Al-free is not a problem, however in order to exert the effect of stabilization, adding by 0.050 mass % or above is preferable. On the other hand, when Al is added by a large quantity exceeding 1.000 mass %, oxide of a quantity more than required for stabilization is generated, and the spatters increase. Therefore, the range of Al is to be 1.000 mass % or below, preferably 0.050-1.000 mass %.

### (Mo: 15.000 Mass % or Below)

By adding Mo, the strength of the weld metal is increased, carbide is formed, and the mechanical properties are improved. Also, Mo is a ferrite generating element as well. Although even Mo-free is not a problem, in order to adjust the strength and to adjust the quantity of ferrite, adding by 0.05 mass % or above is preferable. On the other hand, when Mo is added exceeding 15.000 mass %, the strength becomes excessively high and cracking occurs. Therefore, Mo is to be 15.000 mass % or below.

### (Nb: 5.00 Mass % or Below)

Nb acts as a ferrite generating element and becomes a strong carbide generating element. Nb increases the strength of the weld metal. Also, although Nb-free is not a problem in order to prevent Cr from being carbidized and to secure corrosion resistance, adding by 0.50 mass % or above is preferable. Further, when Nb is added exceeding 5.00 mass %, cracking occurs due to excessively high strength and, if Ni content is high, liquefaction cracking in the grain boundary due to excessive deposition of NbC occurs. Therefore, Nb is to be made 5.00 mass % or below, and preferably to be in the range of 0.50-5.00 mass %.

### (N: 0.0800 Mass % or Below)

N generates nitride of Ti, Al and the like, is effective in refining the grain and the like, and is a strong austenite generating element. When N is added exceeding 0.0800 mass %, (1) all of Ti becomes nitride and carbide of Cr is easily generated, or (2) due to generation of nitride of Cr, required Cr quantity comes to be short of and stress corrosion cracking occurs. Because carbide also can refine the grain, even N-free is not a problem. Therefore N is to be 0.0800 mass % or below.

### (Cu: 5.00 Mass % or Below)

Cu is an austenite generating element and has an effect of enhancing the strength of the weld metal. Although even Cu-free is not a problem, Cu may be added according to the necessity in order to secure the strength. On the other hand, when Cu is added exceeding 5.00 mass %, grain boundary embrittlement is caused and cracking occurs. Therefore Cu is to be 5.00 mass % or below.

### (V: 1.000 Mass % or Below)

V has High Affinity Against C and N and Forms Stable Carbide and nitride. Although even V-free is not a problem, V may be added according to the necessity in order to reduce the quantity of C and N. On the other hand, when V is added exceeding 1.000 mass %, the strength becomes excessively high and cracking occurs. Therefore, V is to be 1.000 mass % or below.

Furthermore, Co, Ta and W may be contained by 5 mass % or below, 1 mass % or below and 5 mass % or below respectively (total of each content in the outer sheath and flux) according to the necessity in order to improve corrosion resistance.

The material of the outer sheath, whether it is mild steel or stainless steel, is not restricted particularly as far as the composition in the total weight of the flux-cored welding wire is within the stipulated range described above. However, from the viewpoint of making the wire itself corrosion resistant and hard to be rusted, stainless steel is preferable for the outer sheath.

Also, the flux is composed of those obtained by grinding metallic materials of respective stipulated elements, respective oxides, alloys and the like.

### (Filling Factor of Flux)

The filling factor of the flux of the flux-cored welding wire in relation with the present invention is preferable to be approximately 7-27 mass %. The reason is that the effect of stabilizing an arc in the pure Ar gas welding atmosphere is lost when the filling factor of the flux is below 7 mass % or exceeds 27 mass %.

Also, the filling factor of the flux is stipulated by percentage of the mass of the flux filled up inside the outer sheath with respect to the total mass of the wire (outer sheath+flux).

### {Method for Manufacturing Flux-Cored Welding Wire}

The method for manufacturing the flux-cored welding wire is not limited particularly, and general manufacturing process can be applied. The flux-cored welding wire can be manufactured by, for example, the steps of forming the hoop of mild steel or stainless steel into U-shape, filling up the U-shape formed hoop with the flux, thereafter forming it into a tubular shape with the flux being filled up therein, and drawing the wire down to a target diameter.

### {Method for Arc Overlay Welding}

The method for arc overlay welding in relation with the present invention is characterized to use pure Ar gas as a shielding gas and to use the flux-cored welding wire having the composition described above. Also, it is preferable to perform arc welding using the pulse current as the welding current.

Below, the pure Ar gas and the pulse condition will be described in detail.

### (Ar Gas Kind: Class 1 or Class 2 of JIS K 1105)

The pure Ar gas applied to the present invention is not pure 100% Ar, but the pure Ar of the industrial product. JIS K 1105 stipulates Ar for industrial use which reads Class 1: 99.99% or above purity, and Class 2: 99.90% or above purity. Those with the purity stipulated above are applicable to the present invention. Further, those with the purity lower than that described above are also applicable, however the effect of reducing the quantity of fume and lowering the dilution ratio is inferior.

### (Pulse Condition: Peak Current, Peak Current Period)

With respect to the welding machine, a constant voltage characteristic power source for general gas metal arc welding use is employed. For pure Ar gas shielded welding, the pulse is recommendable in order to further improve weldability. The pulse is set by the peak current and the peak current period. In the range of peak current: 350-550 A and peak current period: 0.5-3.5 msec (the peak current is 350-550 A when the peak current period is 0.8-3.0 msec, the peak current is 500-550 A when the peak current period is 0.5 msec or longer and shorter than 0.8 msec, and the peak current is 350-380 A when the peak current period is longer than 3.0 msec and 3.5 msec or shorter), the spatters decrease compared with the case of DC pure Ar gas shielded welding, and improvement of weldability can be confirmed. Therefore, setting of the pulse is to be stipulated as the range described above, preferably peak current: 350-550 A, peak current period: 0.8-3.0 msec.

Further, the base current is 100 A or below in general. Also, the arc welding in which the pulse current is used as the welding current is the welding in which the electrode and an object to be welded are electrified with the peak current and the base current repeatedly alternating with each other to generate an arc. Further, the peak current means the current value of the peak current, whereas the peak current period means the time period per one cycle during which the peak current flows.

The present invention is applied to overlay welding of different materials and the material of the base metal built up is not particularly limited. As the material generally employed, mild steel, heat resisting steel added with Cr and Mo, and the like can be cited.

### Example

Below, an example according to an aspect of the present invention will be described. The flux-cored welding wires (wire Nos. [1]-[35]) with wire diameter: 1.2 mm, outer sheath material: stainless steel (the outer sheath composition shown in the wire No. 39) are shown in Table 1. Also, the flux-cored welding wires (wire Nos. [36]-[41]) whose material of the outer sheath is mild steel and stainless steel with the composition of the outer sheath being changed are shown in Table 2. Further, the compositions of the solid wires for the comparison (wire Nos. [42]-[47]) are shown in Table 3.

TABLE 1

| | Chemical composition of total wire (%) | | | | | | | | | | | | | | Flux |
|---|---|---|---|---|---|---|---|---|---|---|---|---|---|---|---|
| wire No. | C | Si | Mn | P | S | Cr | Ni | Ti | Al | Mo | Nb | N | Cu | V | filling factor (%) |
| [1] | 0.013 | 0.54 | 1.83 | 0.013 | 0.007 | 24.3 | 12.2 | 0.43 | 0.012 | 0.019 | 0.03 | 0.0089 | 0.02 | 0.004 | 22.2 |
| [2] | 0.015 | 1.24 | 1.79 | 0.003 | 0.019 | 22.4 | 12.4 | 0.35 | 0.940 | 0.522 | 0.67 | 0.0048 | 1.22 | 0.003 | 21.2 |
| [3] | 0.012 | 0.02 | 0.24 | 0.003 | 0.016 | 23.6 | 12.4 | 0.26 | 0.320 | 0.021 | 0.23 | 0.0078 | 0.03 | 0.005 | 18.4 |
| [4] | 0.028 | 0.46 | 0.13 | 0.002 | 0.017 | 15.9 | 5.7 | 0.27 | 0.280 | 0.008 | 0.57 | 0.0042 | 0.02 | 0.002 | 24.8 |
| [5] | 0.002 | 0.82 | 1.84 | 0.002 | 0.007 | 23.8 | 15.3 | 0.89 | 0.022 | 0.021 | 0.04 | 0.0142 | 0.02 | 0.540 | 21.2 |
| [6] | 0.015 | 1.64 | 1.73 | 0.002 | 0.006 | 28.8 | 13.8 | 0.02 | 0.013 | 0.023 | 0.01 | 0.0480 | 0.04 | 0.052 | 22.4 |
| [7] | 0.120 | 14.21 | 0.02 | 0.002 | 0.006 | 22.5 | 14.5 | 0.42 | 0.012 | 1.300 | 1.50 | 0.0630 | 0.04 | 0.930 | 26.3 |
| [8] | 0.023 | 8.94 | 0.57 | 0.047 | 0.004 | 19.2 | 12.6 | 0.14 | 0.002 | 11.310 | 1.62 | 0.0121 | 0.05 | 0.002 | 22.5 |
| [9] | 0.012 | 0.04 | 19.68 | 0.002 | 0.048 | 29.8 | 13.6 | 0.25 | 0.024 | 0.045 | 3.12 | 0.0043 | 0.04 | 0.004 | 22.5 |
| [10] | 0.180 | 0.52 | 3.21 | 0.003 | 0.008 | 38.2 | 14.5 | 0.51 | 0.003 | 0.021 | 0.05 | 0.0216 | 0.05 | 0.460 | 21.2 |
| [11] | 0.098 | 0.69 | 10.21 | 0.002 | 0.005 | 49.4 | 14.6 | 0.23 | 0.002 | 0.019 | 0.04 | 0.0038 | 0.03 | 0.005 | 15.9 |
| [12] | 0.015 | 0.67 | 2.32 | 0.002 | 0.004 | 23.5 | 13.4 | 0.14 | 0.021 | 0.018 | 4.69 | 0.0042 | 2.41 | 0.001 | 21.2 |
| [13] | 0.009 | 0.35 | 1.93 | 0.002 | 0.006 | 34.2 | 15.3 | 0.12 | 0.003 | 0.022 | 0.04 | 0.0052 | 3.67 | 0.003 | 21.9 |
| [14] | 0.021 | 0.77 | 1.84 | 0.002 | 0.006 | 19.8 | 24.8 | 0.67 | 0.002 | 0.018 | 0.06 | 0.0041 | 4.72 | 0.002 | 24.5 |
| [15] | 0.038 | 0.22 | 0.50 | 0.002 | 0.006 | 29.8 | 58.7 | 0.19 | 0.002 | 0.004 | 0.01 | 0.0036 | 0.01 | 0.002 | 8.3 |
| [16] | 0.033 | 0.22 | 0.50 | 0.002 | 0.005 | 18.7 | 72.9 | 0.47 | 0.002 | 0.005 | 0.23 | 0.0720 | 0.02 | 0.003 | 17.9 |
| [17] | 0.029 | 0.21 | 0.49 | 0.002 | 0.001 | 16.9 | 79.8 | 0.48 | 0.010 | 0.005 | 0.21 | 0.0041 | 0.01 | 0.004 | 21.3 |
| [18] | 0.035 | 0.21 | 0.58 | 0.079 | 0.012 | 25.6 | 13.4 | 0.13 | 0.009 | 0.016 | 0.02 | 0.0046 | 0.03 | 0.003 | 25.3 |
| [19] | 0.029 | 0.31 | 1.78 | 0.004 | 0.082 | 37.0 | 13.8 | 0.53 | 0.009 | 0.021 | 0.03 | 0.0078 | 0.01 | 0.021 | 22.4 |
| [20] | 0.012 | 0.45 | 1.82 | 0.021 | 0.003 | 5.2 | 91.4 | 0.42 | 0.003 | 0.023 | 0.02 | 0.0043 | 0.02 | 0.005 | 22.4 |
| [21] | 0.282 | 0.48 | 1.83 | 0.004 | 0.004 | 38.4 | 13.9 | 0.54 | 0.002 | 0.023 | 0.05 | 0.0122 | 0.04 | 0.004 | 21.6 |
| [22] | 0.172 | 1.67 | 10.34 | 0.003 | 0.003 | 23.4 | 14.5 | 0.12 | 1.670 | 0.027 | 0.03 | 0.0145 | 0.05 | 0.004 | 19.8 |
| [23] | 0.023 | 18.80 | 0.21 | 0.004 | 0.003 | 27.2 | 11.8 | 0.21 | 0.008 | 0.032 | 0.04 | 0.0112 | 0.04 | 0.003 | 21.7 |
| [24] | 0.017 | 0.07 | 22.50 | 0.002 | 0.006 | 25.6 | 7.0 | 0.23 | 0.020 | 0.420 | 0.03 | 0.0236 | 0.02 | 0.002 | 21.9 |
| [25] | 0.011 | 0.48 | 1.73 | 0.003 | 0.005 | 22.6 | 13.4 | 0.12 | 0.013 | 0.002 | 0.04 | 0.0992 | 0.05 | 0.004 | 22.5 |
| [26] | 0.015 | 0.52 | 1.63 | 0.003 | 0.002 | 23.7 | 3.9 | 0.25 | 0.003 | 0.042 | 0.58 | 0.0056 | 0.08 | 0.006 | 22.3 |
| [27] | 0.012 | 0.59 | 1.72 | 0.002 | 0.004 | 55.9 | 13.4 | 0.39 | 0.002 | 0.031 | 0.49 | 0.0051 | 0.08 | 0.003 | 25.8 |
| [28] | 0.031 | 0.57 | 1.79 | 0.002 | 0.005 | 24.8 | 11.9 | 0.42 | 0.004 | 0.025 | 5.96 | 0.0044 | 0.09 | 0.005 | 24.9 |
| [29] | 0.027 | 0.52 | 1.81 | 0.003 | 0.006 | 23.9 | 12.8 | 0.39 | 0.003 | 16.230 | 0.52 | 0.0048 | 0.09 | 0.004 | 22.9 |
| [30] | 0.049 | 0.51 | 1.81 | 0.004 | 0.004 | 24.2 | 13.1 | 0.39 | 0.002 | 0.021 | 0.51 | 0.0051 | 5.81 | 0.003 | 23.1 |
| [31] | 0.052 | 0.53 | 1.78 | 0.003 | 0.004 | 24.5 | 12.9 | 1.14 | 0.002 | 0.018 | 0.05 | 0.0071 | 0.02 | 0.004 | 24.3 |
| [32] | 0.024 | 0.51 | 1.83 | 0.004 | 0.006 | 24.1 | 12.6 | 0.41 | 0.003 | 0.019 | 0.02 | 0.0048 | 0.03 | 1.340 | 22.5 |
| [33] | 0.018 | 0.48 | 1.79 | 0.002 | 0.005 | 22.8 | 12.1 | 0.39 | 0.002 | 0.021 | 0.03 | 0.0042 | 0.01 | 0.005 | 28.7 |
| [34] | 0.016 | 0.52 | 1.82 | 0.004 | 0.005 | 24.8 | 12.3 | 0.41 | 0.003 | 0.031 | 0.04 | 0.0078 | 0.02 | 0.003 | 31.4 |
| [35] | 0.021 | 0.49 | 1.76 | 0.003 | 0.008 | 28.4 | 12.8 | 0.44 | 0.003 | 0.029 | 0.02 | 0.0058 | 0.02 | 0.003 | 6.1 |

TABLE 2

| | Outer | Outer sheath composition | | | | | | | Chemical composition of total wire (%) | | | | | |
|---|---|---|---|---|---|---|---|---|---|---|---|---|---|---|
| wire No. | sheath | C | Si | Mn | P | S | Cr | Ni | C | Si | Mn | P | S | Cr |
| [36] | Mild | 0.015 | 0.01 | 0.20 | 0.006 | 0.011 | — | — | 0.021 | 0.57 | 1.83 | 0.013 | 0.009 | 24.1 |
| [37] | steel | 0.020 | 0.01 | 0.50 | 0.007 | 0.017 | — | — | 0.027 | 0.58 | 1.84 | 0.014 | 0.014 | 24.8 |
| [38] | | 0.020 | 0.12 | 0.90 | 0.006 | 0.015 | — | — | 0.028 | 0.81 | 1.88 | 0.013 | 0.013 | 24.3 |
| [39] | Stainless | 0.020 | 0.21 | 1.00 | 0.005 | 0.012 | 18 | 10 | 0.022 | 0.58 | 1.84 | 0.014 | 0.011 | 24.9 |
| [40] | steel | 0.020 | 0.15 | 1.00 | 0.006 | 0.014 | 18 | 12 | 0.023 | 0.61 | 1.86 | 0.013 | 0.011 | 23.8 |
| [41] | | 0.020 | 0.16 | 1.20 | 0.006 | 0.013 | 20 | 12 | 0.022 | 0.57 | 1.89 | 0.013 | 0.012 | 24.6 |

| | Outer | Chemical composition of total wire (%) | | | | | | | | |
|---|---|---|---|---|---|---|---|---|---|---|
| wire No. | sheath | Ni | Ti | Al | Mo | Nb | N | Cu | V | Flux filling factor (%) |
| [36] | Mild | 12.2 | 0.43 | 0.012 | 0.019 | 0.03 | 0.0056 | 0.02 | 0.004 | 21.4 |
| [37] | steel | 11.9 | 0.52 | 0.013 | 0.023 | 0.02 | 0.0062 | 0.03 | 0.005 | 22.3 |
| [38] | | 12.7 | 0.47 | 0.018 | 0.021 | 0.03 | 0.0061 | 0.02 | 0.004 | 21.8 |
| [39] | Stainless | 12.6 | 0.44 | 0.014 | 0.017 | 0.02 | 0.0054 | 0.03 | 0.005 | 20.2 |
| [40] | steel | 12.2 | 0.47 | 0.017 | 0.022 | 0.02 | 0.0058 | 0.03 | 0.004 | 19.9 |
| [41] | | 12.9 | 0.51 | 0.018 | 0.021 | 0.02 | 0.0071 | 0.03 | 0.004 | 20.1 |

TABLE 3

| | Wire | Chemical composition of solid wire (wt %) | | | | | | | | | | | | | |
|---|---|---|---|---|---|---|---|---|---|---|---|---|---|---|---|
| wire No. | kind | C | Si | Mn | P | S | Cr | Ni | Ti | Al | Mo | Nb | N | Cu | V |
| [42] | Solid | 0.025 | 0.52 | 1.91 | 0.005 | 0.011 | 25.1 | 12.4 | 0.41 | 0.011 | 0.021 | 0.02 | 0.0032 | 0.04 | 0.003 |
| [43] | wire | 0.023 | 0.75 | 1.82 | 0.009 | 0.009 | 34.5 | 12.3 | 0.21 | 0.012 | 0.018 | 0.03 | 0.0041 | 0.03 | 0.002 |
| [44] | | 0.024 | 1.30 | 0.82 | 0.006 | 0.012 | 47.3 | 12.7 | 0.45 | 0.016 | 0.022 | 0.03 | 0.0033 | 0.03 | 0.002 |
| [45] | | 0.045 | 0.78 | 1.52 | 0.008 | 0.012 | 25.7 | 11.9 | 0.44 | 0.013 | 0.022 | 0.02 | 0.0037 | 0.04 | 0.002 |
| [46] | | 0.072 | 0.92 | 1.84 | 0.009 | 0.010 | 17.3 | 12.2 | 0.47 | 0.014 | 0.022 | 0.02 | 0.0043 | 0.03 | 0.003 |
| [47] | | 0.022 | 0.53 | 1.81 | 0.008 | 0.009 | 25.6 | 12.4 | 0.76 | 0.014 | 0.021 | 0.02 | 0.0032 | 0.03 | 0.004 |

The flux-cored welding wires shown in Table 1 and Table 2 as well as the solid wires for the comparison shown in Table 3 were used in gas shielded arc welding, and the spatter quantity, fume quantity, dilution ratio of Cr, bead appearance, and cracking were evaluated. The result is shown in Table 4. Also the result of the evaluation when the pulse condition was changed is shown in Table 5.

TABLE 4

| | Wire | Shielding | Chemical composition of initial layer of weld metal (wt %) | | | | | | | | | | | | | |
|---|---|---|---|---|---|---|---|---|---|---|---|---|---|---|---|---|
| No. | No | gas | C | Si | Mn | P | S | Cr | Ni | Ti | Al | Mo | Wb | N | Cu | V |
| 1 | [1] | Ar | 0.055 | 0.47 | 1.70 | 0.014 | 0.014 | 18.4 | 9.39 | 0.25 | 0.002 | 0.014 | 0.02 | 0.0140 | 0.01 | 0.003 |
| 2 | [2] | Ar | 0.057 | 1.05 | 1.68 | 0.004 | 0.018 | 17.6 | 9.89 | 0.19 | 0.346 | 0.016 | 0.54 | 0.0122 | 0.94 | 0.002 |
| 3 | [3] | Ar | 0.052 | 0.06 | 0.48 | 0.005 | 0.017 | 18.4 | 9.68 | 0.14 | 0.125 | 0.423 | 0.18 | 0.0138 | 0.02 | 0.004 |
| 4 | [4] | Ar | 0.051 | 0.41 | 0.36 | 0.004 | 0.011 | 12.2 | 4.57 | 0.14 | 0.113 | 0.015 | 0.45 | 0.0188 | 0.01 | 0.002 |
| 5 | [5] | Ar | 0.024 | 0.71 | 1.75 | 0.003 | 0.009 | 19.2 | 12.3 | 0.43 | 0.003 | 0.006 | 0.02 | 0.0182 | 0.02 | 0.432 |
| 6 | [6] | Ar | 0.052 | 1.42 | 1.65 | 0.003 | 0.009 | 22.8 | 10.98 | 0.01 | 0.004 | 0.017 | 0.01 | 0.0473 | 0.03 | 0.042 |
| 7 | [7] | Ar | 0.132 | 12.14 | 0.26 | 0.003 | 0.008 | 17.3 | 11.51 | 0.25 | 0.003 | 1.081 | 1.21 | 0.0598 | 0.03 | 0.744 |
| 8 | [8] | Ar | 0.057 | 8.3 | 0.72 | 0.043 | 0.042 | 15.1 | 9.79 | 0.08 | 0.001 | 9.210 | 1.26 | 0.0164 | 0.04 | 0.002 |
| 9 | [9] | Ar | 0.053 | 0.09 | 15.48 | 0.005 | 0.013 | 23.1 | 10.44 | 0.12 | 0.008 | 0.031 | 2.51 | 0.0121 | 0.03 | 0.003 |
| 10 | [10] | Ar | 0.177 | 0.67 | 2.89 | 0.004 | 0.009 | 30.4 | 11.69 | 0.27 | 0.001 | 0.016 | 0.03 | 0.0223 | 0.04 | 0.366 |
| 11 | [11] | Ar | 0.108 | 0.51 | 8.32 | 0.004 | 0.009 | 39.8 | 11.32 | 0.12 | 0.001 | 0.017 | 0.03 | 0.0112 | 0.01 | 0.004 |
| 12 | [12] | Ar | 0.056 | 0.57 | 2.03 | 0.003 | 0.011 | 18.7 | 10.53 | 0.09 | 0.009 | 0.014 | 3.76 | 0.0121 | 1.87 | 0.001 |
| 13 | [13] | Ar | 0.037 | 0.38 | 1.73 | 0.004 | 0.01 | 25.8 | 11.91 | 0.09 | 0.001 | 0.012 | 0.03 | 0.0159 | 2.87 | 0.002 |
| 14 | [14] | Ar | 0.054 | 0.68 | 1.65 | 0.004 | 0.01 | 15.9 | 19.82 | 0.35 | 0.001 | 0.016 | 0.04 | 0.0124 | 3.74 | 0.002 |
| 15 | [15] | Ar | 0.075 | 0.24 | 0.65 | 0.004 | 0.009 | 24.2 | 49.82 | 0.11 | 0.01 | 0.013 | 0.01 | 0.0119 | 0.01 | 0.002 |
| 16 | [16] | Ar | 0.071 | 0.26 | 0.66 | 0.004 | 0.008 | 14.6 | 64.33 | 0.25 | 0.001 | 0.001 | 0.17 | 0.0702 | 0.02 | 0.002 |
| 17 | [17] | Ar | 0.062 | 0.25 | 0.63 | 0.003 | 0.005 | 13.1 | 68.91 | 0.24 | 0.004 | 0.002 | 0.15 | 0.0122 | 0.01 | 0.003 |
| 18 | [36] | Ar | 0.058 | 0.48 | 1.69 | 0.012 | 0.012 | 18.5 | 9.71 | 0.28 | 0.002 | 0.013 | 0.02 | 0.0125 | 0.01 | 0.002 |
| 19 | [37] | Ar | 0.055 | 0.48 | 1.72 | 0.013 | 0.013 | 18.3 | 9.65 | 0.28 | 0.002 | 0.014 | 0.02 | 0.0132 | 0.01 | 0.003 |
| 20 | [38] | Ar | 0.052 | 0.49 | 1.71 | 0.013 | 0.012 | 19.2 | 9.43 | 0.27 | 0.002 | 0.014 | 0.02 | 0.0126 | 0.01 | 0.002 |
| 21 | [39] | Ar | 0.055 | 0.43 | 1.72 | 0.014 | 0.012 | 19.3 | 9.72 | 0.26 | 0.002 | 0.014 | 0.02 | 0.0131 | 0.00 | 0.002 |
| 22 | [40] | Ar | 0.049 | 0.47 | 1.74 | 0.012 | 0.012 | 19.2 | 9.38 | 0.25 | 0.002 | 0.013 | 0.02 | 0.0130 | 0.02 | 0.002 |
| 23 | [41] | Ar | 0.057 | 0.48 | 1.73 | 0.013 | 0.012 | 18.9 | 9.63 | 0.27 | 0.002 | 0.013 | 0.02 | 0.0126 | 0.01 | 0.002 |
| 24 | [1] | Ar + 20%/ | 0.078 | 0.4 | 1.51 | 0.015 | 0.014 | 15.4 | 7.87 | 0.08 | 0.001 | 0.013 | 0.01 | 0.0170 | 0.01 | 0.002 |
| | | CO2 | | | | | | | | | | | | | | |
| 25 | [2] | Ar + 20%/ | 0.081 | 0.84 | 1.42 | 0.005 | 0.016 | 15.0 | 8.72 | 0.08 | 0.167 | 0.012 | 0.41 | 0.0149 | 0.81 | 0.001 |
| | | CO2 | | | | | | | | | | | | | | |
| 26 | [3] | Ar + 20%/ | 0.077 | 0.11 | 0.51 | 0.004 | 0.018 | 15.6 | 8.52 | 0.04 | 0.056 | 0.347 | 0.13 | 0.0161 | 0.01 | 0.003 |
| | | CO2 | | | | | | | | | | | | | | |
| 27 | [4] | Ar + 20%/ | 0.086 | 0.37 | 0.52 | 0.005 | 0.011 | 10.2 | 3.92 | 0.04 | 0.052 | 0.014 | 0.39 | 0.0214 | 0.01 | 0.001 |
| | | CO2 | | | | | | | | | | | | | | |
| 28 | [5] | Ar + 20%/ | 0.049 | 0.54 | 1.54 | 0.004 | 0.011 | 16.5 | 10.55 | 0.14 | 0.002 | 0.016 | 0.01 | 0.0174 | 0.01 | 0.345 |
| | | CO2 | | | | | | | | | | | | | | |
| 29 | [1] | 100% | 0.112 | 0.36 | 1.41 | 0.015 | 0.012 | 14.6 | 4.51 | 0.04 | 0.001 | 0.009 | 0.01 | 0.0189 | 0.01 | 0.002 |
| | | CO2 | | | | | | | | | | | | | | |
| 30 | [2] | 100% | 0.108 | 0.59 | 1.26 | 0.008 | 0.011 | 14.9 | 4.79 | 0.02 | 0.054 | 0.010 | 0.37 | 0.0159 | 0.72 | 0.001 |
| | | CO2 | | | | | | | | | | | | | | |
| 31 | [3] | 100% | 0.104 | 0.13 | 0.72 | 0.007 | 0.019 | 14.6 | 4.61 | 0.01 | 0.011 | 0.285 | 0.01 | 0.0181 | 0.01 | 0.002 |
| | | CO2 | | | | | | | | | | | | | | |
| 32 | [4] | 100% | 0.103 | 0.31 | 0.68 | 0.006 | 0.012 | 10.8 | 2.07 | 0.01 | 0.009 | 0.011 | 0.27 | 0.0223 | 0.01 | 0.001 |
| | | CO2 | | | | | | | | | | | | | | |
| 33 | [5] | 100% | 0.089 | 0.49 | 1.42 | 0.006 | 0.013 | 15.4 | 5.48 | 0.07 | 0.001 | 0.011 | 0.01 | 0.0209 | 0.01 | 0.259 |
| | | CO2 | | | | | | | | | | | | | | |
| 34 | [18] | Ar | 0.068 | 0.25 | 0.12 | 0.069 | 0.011 | 20.2 | 10.6 | 0.08 | 0.005 | 0.011 | 0.02 | 0.0134 | 0.02 | 0.002 |
| 35 | [19] | Ar | 0.062 | 0.33 | 1.69 | 0.004 | 0.074 | 28.1 | 11.1 | 0.29 | 0.005 | 0.017 | 0.02 | 0.0146 | 0.01 | 0.014 |
| 36 | [20] | Ar | 0.053 | 0.42 | 1.71 | 0.018 | 0.003 | 4.0 | 72.7 | 0.23 | 0.001 | 0.018 | 0.02 | 0.0120 | 0.01 | 0.004 |
| 37 | [21] | Ar | 0.281 | 0.43 | 1.73 | 0.005 | 0.005 | 30.0 | 11.2 | 0.28 | 0.001 | 0.018 | 0.04 | 0.0171 | 0.03 | 0.003 |
| 38 | [22] | Ar | 0.169 | 1.45 | 8.41 | 0.004 | 0.004 | 18.4 | 11.4 | 0.06 | 0.925 | 0.022 | 0.02 | 0.0189 | 0.04 | 0.003 |
| 39 | [23] | Ar | 0.056 | 15.54 | 0.38 | 0.006 | 0.004 | 21.1 | 9.73 | 0.11 | 0.004 | 0.024 | 0.03 | 0.0189 | 0.03 | 0.002 |
| 40 | [24] | Ar | 0.058 | 0.12 | 19.70 | 0.002 | 0.007 | 19.3 | 5.02 | 0.13 | 0.011 | 0.326 | 0.02 | 0.0241 | 0.02 | 0.002 |
| 41 | [25] | Ar | 0.051 | 0.42 | 1.62 | 0.004 | 0.006 | 17.4 | 10.42 | 0.07 | 0.007 | 0.001 | 0.03 | 0.0916 | 0.04 | 0.003 |
| 42 | [26] | Ar | 0.058 | 0.44 | 1.52 | 0.003 | 0.003 | 18.1 | 3.09 | 0.14 | 0.001 | 0.028 | 0.42 | 0.0131 | 0.06 | 0.005 |
| 43 | [27] | Ar | 0.053 | 0.49 | 1.52 | 0.003 | 0.005 | 43.2 | 10.11 | 0.24 | 0.001 | 0.021 | 0.38 | 0.0128 | 0.06 | 0.002 |
| 44 | [28] | Ar | 0.066 | 0.51 | 1.61 | 0.003 | 0.005 | 19.4 | 9.23 | 0.25 | 0.002 | 0.019 | 4.84 | 0.0122 | 0.07 | 0.005 |
| 45 | [29] | Ar | 0.061 | 0.48 | 1.73 | 0.004 | 0.007 | 19.0 | 9.87 | 0.23 | 0.001 | 14.940 | 0.42 | 0.0120 | 0.07 | 0.003 |
| 46 | [30] | Ar | 0.077 | 0.48 | 1.74 | 0.008 | 0.008 | 18.9 | 10.21 | 0.21 | 0.001 | 0.015 | 0.41 | 0.0120 | 4.71 | 0.002 |
| 47 | [31] | Ar | 0.076 | 0.47 | 1.75 | 0.005 | 0.006 | 19.2 | 10.01 | 0.78 | 0.001 | 0.012 | 0.04 | 0.0126 | 0.01 | 0.003 |
| 48 | [32] | Ar | 0.052 | 0.48 | 1.72 | 0.004 | 0.006 | 19.3 | 9.78 | 0.22 | 0.001 | 0.014 | 0.01 | 0.0116 | 0.02 | 0.004 |
| 49 | [33] | Ar | 0.047 | 0.46 | 1.74 | 0.003 | 0.004 | 18.1 | 9.69 | 0.22 | 0.001 | 0.015 | 0.02 | 0.0111 | 0.01 | 0.003 |
| 50 | [34] | Ar | 0.045 | 0.47 | 1.75 | 0.004 | 0.006 | 19.5 | 9.72 | 0.21 | 0.001 | 0.012 | 0.02 | 0.0128 | 0.01 | 0.001 |
| 51 | [35] | Ar | 0.051 | 0.47 | 1.71 | 0.003 | 0.006 | 22.6 | 9.74 | 0.23 | 0.001 | 0.014 | 0.01 | 0.0118 | 0.01 | 0.002 |
| 52 | [42] | Ar | 0.052 | 0.47 | 1.82 | 0.006 | 0.009 | 19.8 | 10.31 | 0.23 | 0.003 | 0.018 | 0.01 | 0.0078 | 0.03 | 0.002 |
| | | (solid) | | | | | | | | | | | | | | |
| 53 | [43] | Ar | 0.064 | 0.67 | 1.76 | 0.005 | 0.009 | 26.8 | 9.82 | 0.11 | 0.004 | 0.011 | 0.02 | 0.0081 | 0.02 | 0.001 |
| | | (solid) | | | | | | | | | | | | | | |
| 54 | [44] | Ar | 0.083 | 1.11 | 0.98 | 0.006 | 0.010 | 37.8 | 10.15 | 0.25 | 0.003 | 0.013 | 0.01 | 0.0078 | 0.02 | 0.001 |
| | | (solid) | | | | | | | | | | | | | | |
| 55 | [45] | Ar | 0.078 | 0.63 | 1.47 | 0.006 | 0.008 | 19.9 | 10.22 | 0.22 | 0.002 | 0.012 | 0.01 | 0.0079 | 0.01 | 0.001 |
| | | (solid) | | | | | | | | | | | | | | |
| 56 | [46] | Ar | 0.089 | 0.79 | 1.72 | 0.004 | 0.009 | 13.7 | 10.24 | 0.24 | 0.004 | 0.013 | 0.01 | 0.0088 | 0.02 | 0.002 |
| | | (solid) | | | | | | | | | | | | | | |
| 57 | [47] | Ar | 0.067 | 0.44 | 1.74 | 0.007 | 0.008 | 20.2 | 10.72 | 0.37 | 0.002 | 0.014 | 0.01 | 0.0082 | 0.02 | 0.002 |
| | | (solid) | | | | | | | | | | | | | | |

| | | | | | |
|---|---|---|---|---|---|
| | Spatter | | Dilution | | |
| | quantity | Fume | rate of Cr | Bead | |
| No. | (g/min) | (mg/min) | (%) | appearance | Cracking |

| | | | | | | | | | |
|---|---|---|---|---|---|---|---|---|---|
| 1 | 0.61 | ∘ | 239 | ∘ | 24.3 | ∘ | ∘ | No | Example |
| 2 | 0.58 | ∘ | 223 | ∘ | 21.3 | ∘ | ∘ | No | Example |
| 3 | 0.60 | ∘ | 246 | ∘ | 22.0 | ∘ | ∘ | No | Example |
| 4 | 0.61 | ∘ | 236 | ∘ | 23.3 | ∘ | ∘ | No | Example |
| 5 | 0.72 | ∘ | 221 | ∘ | 19.3 | ∘ | ∘ | No | Example |
| 6 | 0.69 | ∘ | 236 | ∘ | 21.2 | ∘ | ∘ | No | Example |
| 7 | 0.63 | ∘ | 222 | ∘ | 23.0 | ∘ | ∘ | No | Example |
| 8 | 0.62 | ∘ | 235 | ∘ | 21.2 | ∘ | ∘ | No | Example |
| 9 | 0.67 | ∘ | 258 | ∘ | 22.3 | ∘ | ∘ | No | Example |
| 10 | 0.01 | ∘ | 246 | ∘ | 20.4 | ∘ | ∘ | No | Example |
| 11 | 0.68 | ∘ | 266 | ∘ | 19.8 | ∘ | ∘ | No | Example |
| 12 | 0.64 | ∘ | 236 | ∘ | 20.4 | ∘ | ∘ | No | Example |
| 13 | 0.61 | ∘ | 241 | ∘ | 24.6 | ∘ | ∘ | No | Example |
| 14 | 0.58 | ∘ | 231 | ∘ | 19.5 | ∘ | ∘ | No | Example |
| 15 | 0.81 | ∘ | 225 | ∘ | 18.8 | ∘ | ∘ | No | Example |
| 16 | 0.59 | ∘ | 229 | ∘ | 21.9 | ∘ | ∘ | No | Example |
| 17 | 0.64 | ∘ | 243 | ∘ | 22.3 | ∘ | ∘ | No | Example |
| 18 | 0.62 | ∘ | 234 | ∘ | 23.2 | ∘ | ∘ | No | Example |
| 19 | 0.63 | ∘ | 242 | ∘ | 26.2 | ∘ | ∘ | No | Example |
| 20 | 0.62 | ∘ | 237 | ∘ | 21.0 | ∘ | ∘ | No | Example |
| 21 | 0.64 | ∘ | 236 | ∘ | 22.5 | ∘ | ∘ | No | Example |
| 22 | 0.63 | ∘ | 238 | ∘ | 23.5 | ∘ | ∘ | No | Example |
| 23 | 0.65 | ∘ | 236 | ∘ | 23.2 | ∘ | ∘ | No | Example |
| 24 | 0.91 | ∘ | 469 | x | 36.5 | x | ∘ | No | Comparative example |
| 25 | 0.95 | x | 482 | x | 33.1 | x | ∘ | No | Comparative example |
| 26 | 0.85 | x | 468 | x | 34.0 | x | ∘ | No | Comparative example |
| 27 | 0.88 | x | 4.75 | x | 35.8 | x | ∘ | No | Comparative example |
| 28 | 0.84 | x | 462 | x | 30.6 | x | ∘ | No | Comparative example |
| 29 | 1.24 | x | 923 | x | 39.2 | x | ∘ | No | Comparative example |
| 30 | 1.34 | x | 908 | x | 33.5 | x | ∘ | No | Comparative example |
| 31 | 1.19 | x | 943 | x | 36.1 | x | ∘ | No | Comparative example |
| 32 | 1.25 | x | 921 | x | 32.1 | x | ∘ | No | Comparative example |
| 33 | 1.21 | x | 937 | x | 35.2 | x | ∘ | No | Comparative example |
| 34 | 0.87 | ∘ | 243 | ∘ | 20.9 | ∘ | ∘ | Yes | Comparative example |
| 35 | 0.56 | ∘ | 257 | ∘ | 24.1 | ∘ | ∘ | Yes | Comparative example |
| 36 | 0.64 | ∘ | 251 | ∘ | 22.9 | ∘ | ∘ | Yes | Comparative example |
| 37 | 0.81 | x | 239 | ∘ | 21.6 | ∘ | ∘ | Yes | Comparative example |
| 38 | 0.86 | x | 241 | ∘ | 21.4 | ∘ | x | No | Comparative example |
| 39 | 0.72 | ∘ | 265 | ∘ | 22.3 | ∘ | x | Yes | Comparative example |
| 40 | 0.74 | ∘ | 238 | ∘ | 24.8 | ∘ | x | No | Comparative example |
| 41 | 0.68 | ∘ | 247 | ∘ | 23.1 | ∘ | ∘ | Yes | Comparative example |
| 42 | 0.51 | ∘ | 267 | ∘ | 23.5 | ∘ | ∘ | Yes | Comparative example |
| 43 | 0.62 | ∘ | 271 | ∘ | 22.7 | ∘ | ∘ | Yes | Comparative example |
| 44 | 0.65 | ∘ | 289 | ∘ | 21.7 | ∘ | ∘ | Yes | Comparative example |
| 45 | 0.01 | ∘ | 289 | ∘ | 20.5 | ∘ | ∘ | Yes | Comparative example |
| 46 | 0.59 | ∘ | 289 | ∘ | 21.7 | ∘ | ∘ | Yes | Comparative example |
| 47 | 0.84 | x | 249 | ∘ | 21.6 | ∘ | x | No | Comparative example |
| 48 | 0.68 | ∘ | 252 | ∘ | 19.9 | ∘ | ∘ | Yes | Comparative example |
| 49 | 0.87 | x | 244 | ∘ | 20.6 | ∘ | x | No | Comparative example |
| 50 | 0.93 | x | 249 | ∘ | 21.4 | ∘ | x | No | Comparative example |
| 51 | 0.98 | x | 262 | ∘ | 20.4 | ∘ | x | No | Comparative example |
| 52 | 0.92 | x | 188 | ∘ | 21.1 | ∘ | x | No | Comparative example |
| 53 | 0.95 | x | 172 | ∘ | 22.3 | ∘ | x | No | Comparative example |
| 54 | 0.68 | x | 176 | ∘ | 20.1 | ∘ | x | No | Comparative example |
| 55 | 0.91 | x | 162 | ∘ | 22.5 | ∘ | x | No | Comparative example |
| 56 | 0.94 | x | 177 | ∘ | 20.8 | ∘ | x | No | Comparative example |
| 57 | 0.84 | x | 181 | ∘ | 21.1 | ∘ | x | No | Comparative example |

TABLE 5

| | | | | Peak | | | | | | | | | | | | | | |
|---|---|---|---|---|---|---|---|---|---|---|---|---|---|---|---|---|---|---|
| | | | | current | | | | | | | | | | | | | | |
| | Wire | Shielding | Peak | period | Chemical composition of initial layer of weld metal (wt %) | | | | | | | | | | | | | |
| No. | No | gas | current | (msec) | C | Si | Mn | P | S | Cr | Ni | Ti | Al | Mo | Wb | N | Cu | V |
| 58 | [1] | Ar | 550 | 0.6 | 0.038 | 0.47 | 1.78 | 0.013 | 0.013 | 21.8 | 11.07 | 0.26 | 0.003 | 0.018 | 0.02 | 0.0172 | 0.01 | 0.002 |
| 59 | [1] | Ar | 550 | 0.8 | 0.039 | 0.42 | 1.72 | 0.014 | 0.014 | 22.1 | 11.12 | 0.24 | 0.002 | 0.017 | 0.02 | 0.0170 | 0.01 | 0.001 |
| 60 | [1] | Ar | 550 | 1.2 | 0.038 | 0.48 | 1.74 | 0.013 | 0.014 | 21.7 | 11.06 | 0.24 | 0.002 | 0.017 | 0.02 | 0.0189 | 0.01 | 0.002 |
| 61 | [1] | Ar | 550 | 1.6 | 0.037 | 0.51 | 1.74 | 0.014 | 0.014 | 21.5 | 11.04 | 0.24 | 0.002 | 0.018 | 0.02 | 0.0174 | 0.01 | 0.002 |
| 62 | [1] | Ar | 550 | 2 | 0.036 | 0.48 | 1.27 | 0.014 | 0.014 | 21.6 | 11.04 | 0.25 | 0.002 | 0.017 | 0.02 | 0.0178 | 0.01 | 0.002 |
| 63 | [1] | Ar | 550 | 7.4 | 0.037 | 0.48 | 1.72 | 0.014 | 0.014 | 21.9 | 11.08 | 0.25 | 0.002 | 0.016 | 0.02 | 0.0181 | 0.01 | 0.002 |
| 64 | [1] | Ar | 550 | 7.8 | 0.034 | 0.49 | 1.59 | 0.014 | 0.014 | 21.8 | 11.09 | 0.26 | 0.002 | 0.017 | 0.02 | 0.0165 | 0.01 | 0.002 |
| 65 | [1] | Ar | 520 | 0.6 | 0.037 | 0.51 | 1.77 | 0.014 | 0.014 | 20.6 | 11.11 | 0.25 | 0.002 | 0.017 | 0.02 | 0.0173 | 0.01 | 0.002 |
| 66 | [1] | Ar | 520 | 0.8 | 0.036 | 0.48 | 1.72 | 0.014 | 0.014 | 21.3 | 11.05 | 0.25 | 0.002 | 0.017 | 0.02 | 0.0172 | 0.01 | 0.002 |
| 67 | [1] | Ar | 520 | 1.2 | 0.038 | 0.48 | 1.74 | 0.014 | 0.014 | 23.7 | 11.02 | 0.24 | 0.002 | 0.015 | 0.02 | 0.0174 | 0.01 | 0.002 |
| 68 | [1] | Ar | 520 | 1.6 | 0.007 | 0.48 | 1.74 | 0.014 | 0.014 | 21.8 | 10.97 | 0.24 | 0.002 | 0.018 | 0.02 | 0.0174 | 0.01 | 0.002 |
| 69 | [1] | Ar | 520 | 2 | 0.032 | 0.47 | 1.76 | 0.014 | 0.014 | 21.7 | 11.07 | 0.25 | 0.002 | 0.016 | 0.02 | 0.0178 | 0.01 | 0.001 |
| 70 | [1] | Ar | 520 | 2.4 | 0.034 | 0.48 | 1.73 | 0.013 | 0.014 | 21.6 | 11.04 | 0.26 | 0.002 | 0.016 | 0.02 | 0.0175 | 0.01 | 0.002 |
| 71 | [1] | Ar | 520 | 2.6 | 0.035 | 0.46 | 1.74 | 0.014 | 0.015 | 21.6 | 11.03 | 0.27 | 0.002 | 0.017 | 0.02 | 0.0172 | 0.01 | 0.002 |
| 72 | [1] | Ar | 480 | 0.8 | 0.038 | 0.47 | 1.72 | 0.015 | 0.013 | 21.0 | 11.05 | 0.25 | 0.002 | 0.017 | 0.02 | 0.0179 | 0.01 | 0.002 |
| 73 | [1] | Ar | 480 | 1.2 | 0.039 | 0.46 | 1.77 | 0.014 | 0.013 | 21.8 | 11.04 | 0.25 | 0.002 | 0.017 | 0.02 | 0.0175 | 0.01 | 0.002 |
| 74 | [1] | Ar | 480 | 1.6 | 0.032 | 0.48 | 1.73 | 0.014 | 0.014 | 21.7 | 11.06 | 0.25 | 0.002 | 0.017 | 0.02 | 0.0176 | 0.07 | 0.002 |
| 75 | [1] | Ar | 480 | 2 | 0.033 | 0.47 | 1.74 | 0.014 | 0.014 | 21.8 | 11.08 | 0.24 | 0.003 | 0.017 | 0.02 | 0.0174 | 0.01 | 0.003 |
| 76 | [1] | Ar | 480 | 2.4 | 0.038 | 0.47 | 1.77 | 0.014 | 0.014 | 27.8 | 11.09 | 0.24 | 0.002 | 0.017 | 0.02 | 0.0172 | 0.01 | 0.002 |
| 77 | [1] | Ar | 480 | 2.6 | 0.037 | 0.48 | 1.73 | 0.014 | 0.014 | 21.8 | 11.04 | 0.25 | 0.002 | 0.017 | 0.02 | 0.0174 | 0.01 | 0.003 |
| 78 | [1] | Ar | 450 | 0.8 | 0.034 | 0.49 | 1.74 | 0.014 | 0.014 | 21.7 | 11.06 | 0.24 | 0.002 | 0.017 | 0.02 | 0.0173 | 0.01 | 0.002 |
| 79 | [1] | Ar | 450 | 1.2 | 0.037 | 0.47 | 1.76 | 0.013 | 0.014 | 21.8 | 11.04 | 0.25 | 0.003 | 0.016 | 0.02 | 0.0179 | 0.01 | 0.001 |
| 80 | [1] | Ar | 450 | 1.6 | 0.038 | 0.51 | 1.76 | 0.013 | 0.013 | 21.6 | 11.06 | 0.25 | 0.002 | 0.016 | 0.02 | 0.0175 | 0.01 | 0.002 |
| 81 | [1] | Ar | 450 | 2 | 0.038 | 0.42 | 1.77 | 0.014 | 0.014 | 21.8 | 11.02 | 0.24 | 0.002 | 0.018 | 0.02 | 0.0178 | 0.01 | 0.002 |
| 82 | [1] | Ar | 450 | 2.4 | 0.036 | 0.47 | 1.75 | 0.014 | 0.014 | 23.7 | 11.04 | 0.24 | 0.002 | 0.018 | 0.02 | 0.0174 | 0.01 | 0.002 |
| 83 | [1] | Ar | 450 | 2.8 | 0.038 | 0.48 | 1.75 | 0.014 | 0.015 | 23.6 | 11.08 | 0.25 | 0.007 | 0.018 | 0.02 | 0.0174 | 0.01 | 0.002 |
| 84 | [1] | Ar | 420 | 0.8 | 0.034 | 0.48 | 1.71 | 0.014 | 0.014 | 21.7 | 11.09 | 0.24 | 0.002 | 0.017 | 0.02 | 0.0179 | 0.01 | 0.002 |
| 85 | [1] | Ar | 420 | 1.2 | 0.038 | 0.48 | 1.77 | 0.014 | 0.014 | 21.8 | 11.04 | 0.25 | 0.002 | 0.017 | 0.02 | 0.0190 | 0.02 | 0.003 |
| 86 | [1] | Ar | 420 | 1.5 | 0.035 | 0.47 | 1.74 | 0.014 | 0.013 | 21.7 | 11.04 | 0.26 | 0.002 | 0.018 | 0.02 | 0.0170 | 0.01 | 0.001 |
| 87 | [1] | Ar | 420 | 2 | 0.034 | 0.48 | 1.77 | 0.014 | 0.014 | 21.8 | 11.06 | 0.25 | 0.002 | 0.017 | 0.02 | 0.0175 | 0.01 | 0.001 |
| 88 | [1] | Ar | 420 | 2.4 | 0.035 | 0.49 | 1.78 | 0.014 | 0.014 | 21.8 | 11.03 | 0.25 | 0.002 | 0.017 | 0.02 | 0.0174 | 0.01 | 0.002 |
| 89 | [1] | Ar | 420 | 2.8 | 0.035 | 0.46 | 1.74 | 0.014 | 0.014 | 21.7 | 11.04 | 0.26 | 0.002 | 0.016 | 0.02 | 0.0165 | 0.01 | 0.001 |
| 90 | [1] | Ar | 390 | 0.6 | 0.036 | 0.49 | 1.72 | 0.013 | 0.014 | 21.8 | 11.04 | 0.25 | 0.002 | 0.017 | 0.02 | 0.0175 | 0.01 | 0.002 |
| 91 | [1] | Ar | 390 | 1.2 | 0.032 | 0.48 | 1.77 | 0.016 | 0.014 | 21.8 | 11.06 | 0.24 | 0.002 | 0.016 | 0.02 | 0.0173 | 0.01 | 0.002 |
| 92 | [1] | Ar | 390 | 1.6 | 0.036 | 0.51 | 1.73 | 0.014 | 0.014 | 21.8 | 11.04 | 0.25 | 0.002 | 0.018 | 0.02 | 0.0173 | 0.01 | 0.002 |
| 93 | [1] | Ar | 390 | 2 | 0.037 | 0.49 | 1.71 | 0.014 | 0.014 | 21.8 | 11.08 | 0.24 | 0.002 | 0.017 | 0.02 | 0.0175 | 0.01 | 0.002 |
| 94 | [1] | Ar | 390 | 1.4 | 0.038 | 0.46 | 1.72 | 0.014 | 0.014 | 21.8 | 11.07 | 0.25 | 0.002 | 0.018 | 0.02 | 0.0174 | 0.01 | 0.002 |
| 95 | [1] | Ar | 390 | 2.8 | 0.035 | 0.47 | 1.77 | 0.014 | 0.014 | 21.7 | 11.05 | 0.24 | 0.002 | 0.017 | 0.02 | 0.0178 | 0.01 | 0.002 |
| 96 | [1] | Ar | 360 | 0.8 | 0.037 | 0.47 | 1.75 | 0.014 | 0.014 | 21.6 | 11.09 | 0.25 | 0.002 | 0.017 | 0.02 | 0.0175 | 0.01 | 0.002 |
| 97 | [1] | Ar | 360 | 1.2 | 0.038 | 0.49 | 1.74 | 0.014 | 0.014 | 21.6 | 11.03 | 0.24 | 0.002 | 0.017 | 0.02 | 0.0175 | 0.01 | 0.002 |
| 98 | [1] | Ar | 360 | 1.6 | 0.038 | 0.47 | 1.72 | 0.014 | 0.014 | 21.7 | 11.04 | 0.25 | 0.003 | 0.017 | 0.02 | 0.0170 | 0.01 | 0.001 |
| 99 | [1] | Ar | 360 | 2 | 0.032 | 0.48 | 1.75 | 0.014 | 0.014 | 21.7 | 11.03 | 0.24 | 0.002 | 0.016 | 0.02 | 0.0180 | 0.01 | 0.002 |
| 100 | [1] | Ar | 360 | 2.4 | 0.038 | 0.51 | 1.73 | 0.014 | 0.014 | 21.7 | 11.04 | 0.25 | 0.002 | 0.018 | 0.02 | 0.0177 | 0.01 | 0.002 |
| 101 | [1] | Ar | 360 | 2.8 | 0.032 | 0.52 | 1.78 | 0.014 | 0.014 | 21.7 | 11.05 | 0.24 | 0.002 | 0.017 | 0.02 | 0.0180 | 0.01 | 0.001 |
| 102 | [1] | Ar | 550 | 3.2 | 0.033 | 0.48 | 1.74 | 0.014 | 0.014 | 21.7 | 11.02 | 0.25 | 0.002 | 0.010 | 0.02 | 0.0172 | 0.01 | 0.001 |
| 103 | [1] | Ar | 550 | 3.2 | 0.035 | 0.44 | 1.76 | 0.013 | 0.014 | 21.8 | 11.04 | 0.25 | 0.002 | 0.017 | 0.02 | 0.0173 | 0.01 | 0.002 |
| 104 | [1] | Ar | 570 | 3.2 | 0.035 | 0.47 | 1.74 | 0.014 | 0.014 | 21.8 | 11.08 | 0.24 | 0.003 | 0.017 | 0.02 | 0.0175 | 0.01 | 0.002 |
| 105 | [1] | Ar | 480 | 0.6 | 0.038 | 0.51 | 1.27 | 0.014 | 0.014 | 21.9 | 11.04 | 0.24 | 0.002 | 0.017 | 0.02 | 0.0173 | 0.01 | 0.002 |
| 106 | [1] | Ar | 480 | 1.2 | 0.035 | 0.46 | 1.75 | 0.015 | 0.014 | 21.7 | 11.05 | 0.25 | 0.002 | 0.018 | 0.02 | 0.0174 | 0.01 | 0.002 |
| 107 | [1] | Ar | 450 | 0.6 | 0.037 | 0.47 | 1.78 | 0.014 | 0.014 | 21.7 | 11.05 | 0.24 | 0.002 | 0.017 | 0.02 | 0.0174 | 0.01 | 0.002 |
| 108 | [1] | Ar | 450 | 3.2 | 0.038 | 0.47 | 1.76 | 0.014 | 0.014 | 21.7 | 11.03 | 0.24 | 0.002 | 0.017 | 0.02 | 0.0174 | 0.01 | 0.002 |
| 109 | [1] | Ar | 420 | 0.6 | 0.037 | 0.48 | 1.37 | 0.014 | 0.014 | 21.7 | 11.06 | 0.24 | 0.002 | 0.017 | 0.02 | 0.0180 | 0.01 | 0.001 |
| 110 | [1] | Ar | 420 | 3.2 | 0.032 | 0.44 | 1.78 | 0.014 | 0.014 | 21.0 | 11.04 | 0.24 | 0.002 | 0.017 | 0.02 | 0.0178 | 0.01 | 0.002 |
| 111 | [1] | Ar | 390 | 0.6 | 0.033 | 0.45 | 1.77 | 0.013 | 0.014 | 21.7 | 11.05 | 0.24 | 0.002 | 0.017 | 0.02 | 0.0175 | 0.01 | 0.002 |
| 112 | [1] | Ar | 390 | 3.2 | 0.033 | 0.46 | 1.76 | 0.014 | 0.014 | 21.7 | 11.06 | 0.24 | 0.002 | 0.016 | 0.02 | 0.0179 | 0.01 | 0.002 |
| 113 | [1] | Ar | 360 | 0.8 | 0.036 | 0.48 | 1.78 | 0.014 | 0.014 | 21.7 | 11.04 | 0.24 | 0.002 | 0.016 | 0.02 | 0.0174 | 0.01 | 0.002 |
| 114 | [1] | Ar | 330 | 0.6 | 0.038 | 0.46 | 1.78 | 0.014 | 0.014 | 21.7 | 11.09 | 0.24 | 0.002 | 0.017 | 0.02 | 0.0174 | 0.01 | 0.002 |
| 115 | [1] | Ar | 330 | 0.8 | 0.038 | 0.45 | 1.77 | 0.014 | 0.014 | 21.7 | 11.05 | 0.24 | 0.002 | 0.017 | 0.02 | 0.0175 | 0.01 | 0.002 |
| 116 | [1] | Ar | 330 | 1.2 | 0.032 | 0.45 | 1.76 | 0.014 | 0.014 | 21.7 | 11.04 | 0.24 | 0.002 | 0.017 | 0.02 | 0.0178 | 0.01 | 0.002 |
| 117 | [1] | Ar | 330 | 1.8 | 0.036 | 0.47 | 1.75 | 0.014 | 0.015 | 21.6 | 11.02 | 0.24 | 0.002 | 0.017 | 0.02 | 0.0178 | 0.01 | 0.002 |
| 118 | [1] | Ar | 330 | 2 | 0.036 | 0.47 | 1.76 | 0.014 | 0.014 | 21.7 | 11.04 | 0.24 | 0.002 | 0.017 | 0.02 | 0.0172 | 0.01 | 0.002 |
| 119 | [1] | Ar | 330 | 2.4 | 0.039 | 0.48 | 1.78 | 0.014 | 0.014 | 21.7 | 10.97 | 0.25 | 0.002 | 0.017 | 0.02 | 0.0188 | 0.01 | 0.003 |
| 120 | [1] | Ar | 330 | 2.8 | 0.038 | 0.48 | 1.75 | 0.014 | 0.014 | 21.7 | 11.02 | 0.25 | 0.002 | 0.017 | 0.02 | 0.0174 | 0.01 | 0.002 |
| 121 | [1] | Ar | 330 | 3.2 | 0.038 | 0.49 | 1.77 | 0.014 | 0.014 | 21.7 | 10.95 | 0.24 | 0.002 | 0.017 | 0.02 | 0.0175 | 0.01 | 0.002 |

| | | | | | |
|---|---|---|---|---|---|
| | Spatter | | Dilution | | |
| | quantity | Fume | rate | Bead | |
| No. | (g/min) | (mg/min) | of Cr (%) | appearance | Cracking |

| | | | | | | | | | |
|---|---|---|---|---|---|---|---|---|---|
| 58 | 0.45 | ∘ | 282 | ∘ | 10.2 | ∘ | ∘ | No | Example |
| 59 | 0.32 | ∘ | 284 | ∘ | 9.0 | ∘ | ∘ | No | Example |
| 60 | 0.27 | ∘ | 259 | ∘ | 10.6 | ∘ | ∘ | No | Example |
| 61 | 0.29 | ∘ | 268 | ∘ | 11.4 | ∘ | ∘ | No | Example |
| 62 | 0.34 | ∘ | 272 | ∘ | 10.9 | ∘ | ∘ | No | Example |
| 63 | 0.42 | ∘ | 274 | ∘ | 10.0 | ∘ | ∘ | No | Example |
| 64 | 0.43 | ∘ | 284 | ∘ | 10.4 | ∘ | ∘ | No | Example |
| 65 | 0.49 | ∘ | 258 | ∘ | 11.1 | ∘ | ∘ | No | Example |
| 66 | 0.28 | ∘ | 261 | ∘ | 10.8 | ∘ | ∘ | No | Example |
| 67 | 0.27 | ∘ | 269 | ∘ | 10.6 | ∘ | ∘ | No | Example |
| 68 | 0.24 | ∘ | 254 | ∘ | 10.2 | ∘ | ∘ | No | Example |
| 69 | 0.25 | ∘ | 267 | ∘ | 10.9 | ∘ | ∘ | No | Example |
| 70 | 0.24 | ∘ | 271 | ∘ | 10.3 | ∘ | ∘ | No | Example |
| 71 | 0.36 | ∘ | 274 | ∘ | 11.3 | ∘ | ∘ | No | Example |
| 72 | 0.31 | ∘ | 261 | ∘ | 10.4 | ∘ | ∘ | No | Example |
| 73 | 0.28 | ∘ | 264 | ∘ | 10.4 | ∘ | ∘ | No | Example |
| 74 | 0.26 | ∘ | 268 | ∘ | 10.7 | ∘ | ∘ | No | Example |
| 75 | 0.26 | ∘ | 273 | ∘ | 10.3 | ∘ | ∘ | No | Example |
| 76 | 0.24 | ∘ | 269 | ∘ | 10.2 | ∘ | ∘ | No | Example |
| 77 | 0.39 | ∘ | 273 | ∘ | 10.4 | ∘ | ∘ | No | Example |
| 78 | 0.47 | ∘ | 257 | ∘ | 10.8 | ∘ | ∘ | No | Example |
| 79 | 0.39 | ∘ | 263 | ∘ | 10.4 | ∘ | ∘ | No | Example |
| 80 | 0.32 | ∘ | 259 | ∘ | 10.2 | ∘ | ∘ | No | Example |
| 81 | 0.26 | ∘ | 268 | x | 10.5 | ∘ | ∘ | No | Example |
| 82 | 0.28 | ∘ | 264 | x | 10.5 | ∘ | ∘ | No | Example |
| 83 | 0.41 | ∘ | 258 | x | 10.9 | ∘ | ∘ | No | Example |
| 84 | 0.38 | ∘ | 268 | x | 10.9 | ∘ | ∘ | No | Example |
| 85 | 0.39 | ∘ | 257 | x | 10.4 | ∘ | ∘ | No | Example |
| 86 | 0.34 | ∘ | 261 | x | 10.5 | ∘ | ∘ | No | Example |
| 87 | 0.32 | ∘ | 260 | x | 10.2 | ∘ | ∘ | No | Example |
| 88 | 0.42 | ∘ | 262 | x | 10.3 | ∘ | ∘ | No | Example |
| 89 | 0.51 | ∘ | 265 | x | 10.7 | ∘ | ∘ | No | Example |
| 90 | 0.52 | ∘ | 253 | x | 10.4 | ∘ | ∘ | No | Example |
| 91 | 0.54 | ∘ | 258 | ∘ | 10.2 | ∘ | ∘ | No | Example |
| 92 | 0.47 | ∘ | 261 | ∘ | 10.2 | ∘ | ∘ | No | Example |
| 93 | 0.38 | ∘ | 259 | ∘ | 10.3 | ∘ | ∘ | No | Example |
| 94 | 0.36 | ∘ | 263 | ∘ | 10.4 | ∘ | ∘ | No | Example |
| 95 | 0.32 | ∘ | 262 | ∘ | 10.9 | ∘ | ∘ | No | Example |
| 96 | 0.5 | ∘ | 251 | ∘ | 11.2 | ∘ | ∘ | No | Example |
| 97 | 0.44 | ∘ | 254 | ∘ | 11.0 | ∘ | ∘ | No | Example |
| 98 | 0.42 | ∘ | 253 | ∘ | 10.9 | ∘ | ∘ | No | Example |
| 99 | 0.47 | ∘ | 258 | ∘ | 10.8 | ∘ | ∘ | No | Example |
| 100 | 0.39 | ∘ | 252 | ∘ | 10.9 | ∘ | ∘ | No | Example |
| 101 | 0.38 | ∘ | 257 | ∘ | 10.5 | ∘ | ∘ | No | Example |
| 102 | 0.48 | ∘ | 261 | ∘ | 10.6 | ∘ | ∘ | No | Example |
| 103 | 0.62 | x | 278 | ∘ | 10.5 | ∘ | ∘ | No | Comparative |
| | | | | | | | | | example |
| 104 | 0.65 | x | 272 | ∘ | 10.5 | ∘ | ∘ | No | Comparative |
| | | | | | | | | | example |
| 105 | 0.69 | x | 161 | ∘ | 10.0 | ∘ | ∘ | No | Comparative |
| | | | | | | | | | example |
| 106 | 0.64 | x | 268 | ∘ | 10.5 | ∘ | ∘ | No | Comparative |
| | | | | | | | | | example |
| 107 | 0.71 | x | 262 | ∘ | 10.5 | ∘ | ∘ | No | Comparative |
| | | | | | | | | | example |
| 108 | 0.64 | x | 267 | ∘ | 10.5 | ∘ | ∘ | No | Comparative |
| | | | | | | | | | example |
| 109 | 0.74 | x | 259 | ∘ | 10.7 | ∘ | ∘ | No | Comparative |
| | | | | | | | | | example |
| 110 | 0.63 | x | 265 | ∘ | 10.7 | ∘ | ∘ | No | Comparative |
| | | | | | | | | | example |
| 111 | 0.79 | x | 258 | ∘ | 10.5 | ∘ | ∘ | No | Comparative |
| | | | | | | | | | example |
| 112 | 0.64 | x | 262 | ∘ | 10.5 | ∘ | ∘ | No | Comparative |
| | | | | | | | | | example |
| 113 | 0.84 | x | 252 | ∘ | 10.7 | ∘ | ∘ | No | Comparative |
| | | | | | | | | | example |
| 114 | 0.92 | x | 248 | ∘ | 10.8 | ∘ | ∘ | No | Comparative |
| | | | | | | | | | example |
| 115 | 0.89 | x | 251 | ∘ | 10.8 | ∘ | ∘ | No | Comparative |
| | | | | | | | | | example |
| 116 | 0.86 | x | 249 | ∘ | 10.9 | ∘ | ∘ | No | Comparative |
| | | | | | | | | | example |
| 117 | 0.79 | x | 252 | ∘ | 11.0 | ∘ | ∘ | No | Comparative |
| | | | | | | | | | example |
| 118 | 0.82 | x | 252 | ∘ | 10.8 | ∘ | ∘ | No | Comparative |
| | | | | | | | | | example |
| 119 | 0.81 | x | 257 | ∘ | 10.8 | ∘ | ∘ | No | Comparative |
| | | | | | | | | | example |
| 120 | 0.76 | x | 258 | ∘ | 10.7 | ∘ | ∘ | No | Comparative |
| | | | | | | | | | example |
| 121 | 0.74 | x | 253 | ∘ | 10.7 | ∘ | ∘ | No | Comparative |
| | | | | | | | | | example |

The 100% CO₂ gas shielded arc welding condition shown in Table 4 was DC current-voltage: 240 A-32 V, base metal-tip distance: 25 mm, flow rate: 25 L/min, welding speed: 30 cm/min.

The Ar+20% CO₂ gas shielded arc welding condition shown in Table 4 was DC current-voltage: 240 A-30 V, base metal-tip distance: 25 mm, flow rate: 25 L/min, welding speed: 30 cm/min.

The 100% Ar gas shielded arc welding condition shown in Table 4 was DC current-voltage: 240 A-30 V, base metal-tip distance: 25 mm, flow rate: 25 L/min, welding speed: 30 cm/min.

The Ar (solid) gas shielded arc welding condition shown in Table 4 was DC current-voltage: 240 A-32 V, base metal-tip distance: 25 mm, flow rate: 25 L/min, welding speed: 30 cm/min.

The 100% Ar gas shielded arc welding condition (condition in pulsing) shown in Table 5 was as per the peak current and peak current period as shown in Table 5 and the wire feeding speed of 9.8 m/min.

The welding conditions described above were applied commonly to the evaluations described below. Also, SS400 steel represented by the composition shown in Table 6 was used for the base metal.

TABLE 6

| | Example base metal composition | | | | |
|---|---|---|---|---|---|
| Steel kind | C | Si | Mn | P | S |
| SS400 | 0.16 | 0.31 | 1.35 | 0.019 | 0.004 |

### (Measurement of Spatter Quantity)

Commonly to respective examples, the quantity of the spatters generated was measured by arranging boxes made of steel sheet on both sides of the weld bead (more specifically, two boxes of 200 mm height×100 mm width×500 mm length were arranged in the sides of the welding line), performing welding, obtaining all the spatters generated in one minute from inside of the boxes, measuring the total mass of the spatters collected to make the quantity of the spatters (g/min).

In Table 4, the quantity of the spatters measured in Ar+20% CO₂ gas shielded arc welding in which the quantity of the spatters became lowest among the gas conditions usually employed was 0.84-0.95 g/min, therefore 0.80 g/min which was slightly lower than that was adopted as a criterion, the case of 0.80 g/min or above was evaluated not to have improved to which the mark x was given, whereas the case of below 0.80 g/min was evaluated that the spatters had decreased than before to which the mark o was given.

Also, in Table 5, 0.55 g/min which was slightly lower than the measured quantity (0.56-0.68 g/min) of the spatters generated in welding by DC current was adopted as a criterion, the case of 0.55 g/min or above was evaluated that there was no effect of the pulse to which the mark x was given, whereas the case of below 0.55 g/min was evaluated that the spatters had decreased due to the pulse to which the mark o was given.

### (Measurement of Fume Quantity)

The quantity of the fume was measured by obtaining the fume by a method in accordance with JIS Z 3920 and was evaluated. The quantity of the fume measured in Ar+20% CO₂ gas shielded arc welding in which the quantity of the fume became lowest among the gas conditions usually employed was 462-482 mg/min, therefore 450 mg/min which was slightly lower than that was adopted as a criterion, the case of 450 mg/min or above was evaluated not to have improved compared with the conventional technology and the mark x was given, whereas the case of below 450 mg/min was evaluated that the quantity of the fume had improved than before to which the mark o was given.

### (Evaluation of Dilution Ratio of Cr)

In building up of the corrosion resistant welding material, the dilution ratio of Cr is an important factor. The chemical compositions shown in Table 4 and Table 5 are the results of the analysis after sampling the center part of the initial layer of overlay welding (the initial layer of the weld metal). Because Cr was not added in the base metal, the dilution ratio of Cr was calculated by the Cr quantity (wt %) in the initial layer of the weld metal/the Cr quantity (wt %) of the wire. The dilution ratio in Ar+20% CO₂ gas shielded arc welding in which the dilution ratio became lowest among the gas conditions usually employed was 30.4-36.5%, therefore 30% which was slightly lower than that was adopted as a criterion, the case of 30% or above was evaluated not to have improved compared with the conventional technology to which the mark x was given, whereas the case of below 30% was evaluated that the dilution ratio had improved than before to which the mark o was given.

### (Evaluation of Bead Appearance)

The appearance of the bead was evaluated by visual inspection. The bead excellent in linearity with the foot of the bead being in line was given the mark o, whereas the bead determined to have largely snaked was given the mark x.

### (Evaluation of Cracking)

The weld crack test was conducted by the y-type weld crack test in accordance with JIS Z 3158, and presence/absence of the crack on the surface of the weld bead was checked by visual inspection. The case without a crack on the surface was evaluated to be excellent in cracking resistance to which the mark o was given, whereas the case with a crack on the surface was evaluated to be bad in cracking resistance to which the mark x was given.

Here, Table 4 is the result of the evaluation of the wires shown in Table 1 (Nos. [1]-[35]) in each gas shielded welding. Nos. 1-23 represent the embodiments according to the present invention, and Nos. 1-17 thereof are those in which wire Nos. [1]-[17] were evaluated in pure Ar gas shielded welding. In each case, the spatter quantity, fume quantity and dilution ratio were reduced, the bead appearance was excellent, and there was no crack. Further, in Nos. 18-23, the outer sheath was changed (wire Nos. [36]-[41]). Even if the composition of the outer sheath was changed, when the composition of the total wire is same, similar improvement effect can be secured.

On the other hand, Nos. 24-57 shown in Table 4 are the comparative examples. Nos. 24-28 are of the examples in which the wire Nos. [1]-[5] were evaluated in Ar+20% CO₂ gas shielded welding, which is a conventional welding method. Also, Nos. 29-33 are of the examples in which the wire Nos. [1]-[5] were evaluated in 100% CO₂ gas shielded welding, and the combination thereof is also a conventional welding method. As shown in the evaluation exhibited in Table 4, the spatter quantity, fume quantity and dilution ratio increase even if the wire is changed in the shielding gas used conventionally.

Nos. 34-51 are those in which wire Nos. [18]-[35] were evaluated in pure Ar gas shielded welding. In No. 34, although the spatter quantity, fume quantity and dilution ratio did not show any problem, the cracking occurred due to excessive addition of P. In No. 35, the cracking occurred due to excessive addition of S. In No. 36, the cracking occurred due to excessively high Ni quantity and low Cr quantity. In No. 37, not only the spatters increased due to excessive addition of C, but also the cracking occurred. In No. 38, due to excessive addition of Al, the anode spot was disturbed, the bead snaked, and the spatters increased. In Nos. 39 and 40, the bead snaked due to excessive addition of Si and Mn respectively. In No. 41, the cracking occurred due to excessive addition of N, whereas in No. 42, Ni quantity was excessively low, martensite+ferrite structure was formed, and the cracking occurred. In No. 43, Cr quantity was excessively high, embrittlement was caused, and the cracking occurred. In Nos. 44, 45 and 46, the strength of the weld metal became excessively high due to excessive addition of Nb, Mo and Cu respectively, and the cracking occurred. In No. 47, due to excessive addition of Ti, the anode point was disturbed, the bead snaked, and the scatters increased as well. In No. 48, the strength of the weld metal became excessively high due to excessive addition of V, and the cracking occurred. In Nos. 49 and 50, the filling factor of the flux was excessively high and the spatters scattered from the flux increased. In No. 51, the filling factor of the flux was excessively low, the molten droplet was not transferred stably, and the spatters increased.

Nos. 52-57 are those in which the solid wires were evaluated in pure Ar gas shielded welding. In each case, the fume quantity, dilution ratio and cracking resistance did not show any problem, however the arc became unstable, the spatters increased, and snaking occurred.

Table 5 shows the result of the cases in which the condition of the pulse current was changed in pure Ar gas shielded welding on the basis of the wire No. [1].

Nos. 58-102 represented the embodiments under the pulse condition, the fume quantity, dilution ratio of Cr, bead appearance and cracking also did not show any problem, and the quantity of the spatters was less than that in welding by DC, which revealed the effect of the pulse.

On the other hand, in Nos. 103-121, good results were obtained with respect to the fume quantity, dilution ratio of Cr, bead appearance and cracking. However, because the pulse deviated from the optimum condition, the quantity of the spatters increased to some degree.

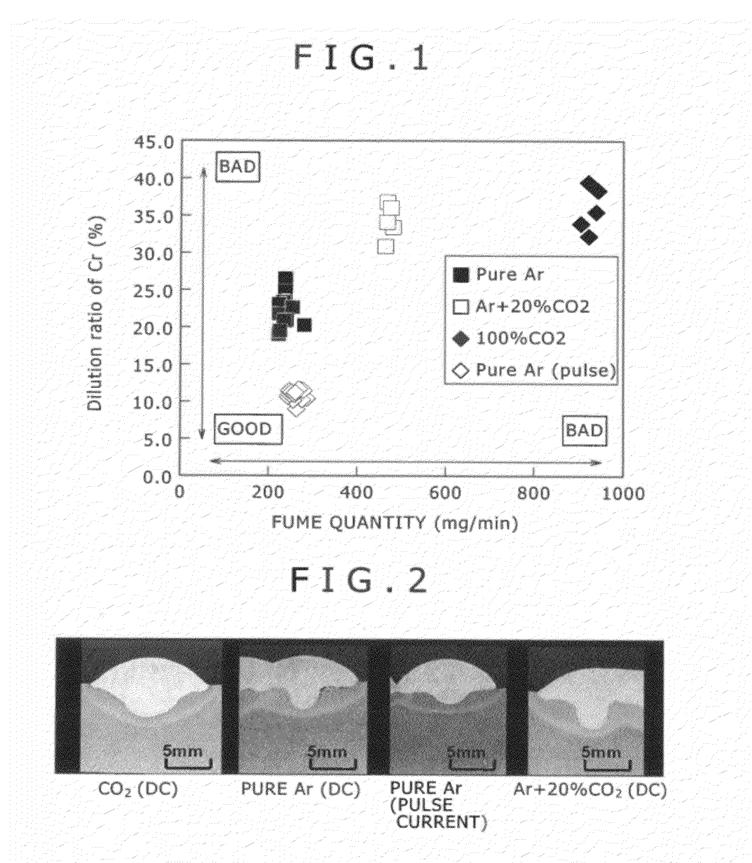

The results of Tables 4 and 5 illustrated from the viewpoints of the quantity of the fume and the dilution ratio of Cr are shown in FIG. 1. It was clarified that, by employing pure Ar for the shielding gas, the quantity of the fume and the dilution ratio of Cr were improved, and that the dilution ratio of Cr was improved by employing pulsing.

Also, FIG. 2 shows the cross-sectional macro photo of each gas shielded welding and pulsed pure Ar gas shielded arc welding. From the photo, it was revealed that the penetration was less and the dilution ratio was less in the pulsed pure Ar gas shielded arc welding.

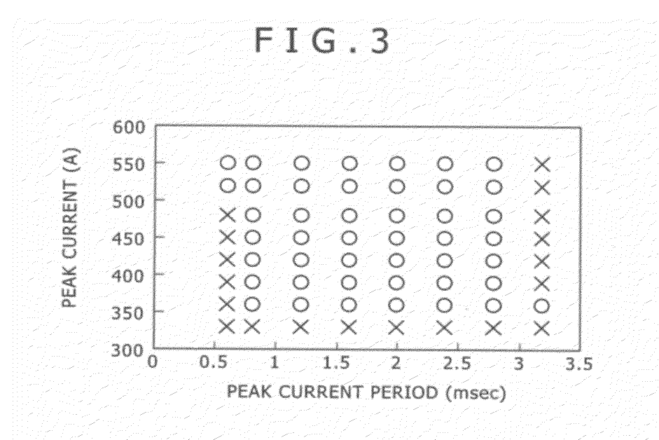

FIG. 3 shows the range of the condition in which the spatters can be reduced when the pulse is applied.

Based on the examples described above, it was proved that the flux-cored welding wire and the method for arc overlay welding satisfying the requirement stipulated in the present invention were superior in weldability (less spatters, less fume) and the dilution ratio.

What is claimed is:

1. A flux-cored welding wire for gas shielded arc welding including flux filled up in an outer sheath and using pure Ar as a shielding gas, containing, as percentage to the total mass of the flux-cored welding wire:
C: 0.20 mass % or below,
Si: 15.00 mass % or below,
Mn: 20.00 mass % or below,
P: 0.0500 mass % or below,
S: 0.0500 mass % or below, and
Cr: 15.0-50.0 mass %,
the remainder comprising Fe and inevitable impurities.

2. The flux-cored welding wire according to claim 1 further containing, as percentage to the total mass of the flux-cored welding wire:
Ni: 5.00-80.00 mass %.

3. The flux-cored welding wire according to claim 1 further containing, as percentage to the total mass of the flux-cored welding wire, one or more kind selected from the group consisting of:
Ti: 1.00 mass % or below,
Al: 1.000 mass % or below,
Mo: 15.000 mass % or below,
Nb: 5.00 mass % or below,
N: 0.0800 mass % or below,
Cu: 5.00 mass % or below, and
V: 1.000 mass % or below.

4. The flux-cored welding wire according to claim 1, wherein stainless steel is used for the outer sheath.

5. The flux-cored welding wire according to claim 1, wherein a filling factor of flux is 7-27 mass % as percentage to the total mass of the flux-cored welding wire.

6. A method for arc overlay welding performing arc welding using the flux-cored welding wire according to claim 1 and using pure Ar as a shielding gas.

7. The method for arc overlay welding according to claim 6, wherein
pulse current is used as welding current in the arc welding;
peak current of the pulse current is 350-550 A, peak current period of the pulse current is 0.5-3.5 msec, and
the peak current is 350-550 A when the peak current period is 0.8-3.0 msec, the peak current is 500-550 A when the peak current period is 0.5 msec or longer and shorter than 0.8 msec, and the peak current is 350-380 A when the peak current period is longer than 3.0 msec and 3.5 msec or shorter.
